(19) United States
(12) Patent Application Publication
(10) Pub. No.: US 2024/0025815 A1
(43) Pub. Date: Jan. 25, 2024

(54) USE OF AN ALUMINOSILICATE GLASS FOR PROVIDING A PLANT WITH SILICON IN AN ASSIMILABLE FORM, METHOD FOR TREATING A PLANT USING THIS GLASS AND NEW POWDER OF THIS GLASS

(71) Applicants: AGRO INNOVATION INTERNATIONAL, Saint-Malo (FR); SAINT-GOBAIN ISOVER, Courbevoie (FR)

(72) Inventors: Mustapha ARKOUN, Saint-Jouan-des-Guérets (FR); Frank JAMOIS, La Chapelle-des-Fougeretz (FR); Jean-Claude YVIN, Saint-Malo (FR); Kamila ROLLI, Asnières-sur-Seine (FR)

(21) Appl. No.: 17/767,614

(22) PCT Filed: Oct. 6, 2020
(86) PCT No.: PCT/FR2020/051744

§ 371 Date: Apr. 8, 2022

(30) Foreign Application Priority Data
Oct. 8, 2019 (FR) 1911152

(51) Int. Cl. C05D 9/02; C03C 3/087; C03C 4/00; C03C 12/00; C05G 5/10

(52) U.S. Cl. CPC C05D 9/02; C03C 3/087; C03C 4/0007; C03C 12/00; C05G 5/10; C03C 2204/00; A01C 21/00

(57) ABSTRACT

The subject-matter of the present invention is the use of an aluminosilicate glass to provide a plant with silicon in assimilable form, a method for treating a plant using this glass and a new powder of said glass.

According to the invention, this aluminosilicate glass comprises the following constituents in a weight content varying within the limits defined below:
SiO₂ 30-60%
Al₂O₃ 10-26%
CaO+MgO+Na₂O+K₂O 15-45%.

The invention finds applications in particular in the agricultural field.

### TECHNICAL FIELD

The present invention generally relates to the use of a specific aluminosilicate glass as a source of silicon to provide a plant with silicon in assimilable form. It also relates to a method for treating a plant using this aluminosilicate glass. Finally, it relates, as a new product, to powders of this aluminosilicate glass.

The invention finds application in particular in the agricultural field.

### PRIOR ART

Silicon is an element that promotes the good vegetative development of plants, such as Solanaceae, Asteraceae, Poaceae and Sinapis Albae. Generally speaking, silicon can only be assimilated by plants in the form of silicic acid. It is generally transported in the transpiratory flow from the roots to the aerial organs where it is accumulated and precipitated to form biogenic opals called phytoliths.

Research over the past several years has shown that absorbed silicon increases the productivity and quality of agricultural crops. In particular, silicon has been shown to improve drought tolerance and slow the wilting of certain plants when irrigation is delayed.

It can also increase the strength of rice or wheat stems, preventing them from collapsing in times of heavy rain or strong winds.

Given these advantages, research has been undertaken to develop compositions to provide silicon to a plant, in an assimilable form.

For example, in document WO 2010/040176, it is proposed to use, as a source of plant-assimilable silicon, soda-lime glass particles containing a level of at least 50% by weight of silica (SiO₂) and at least 2% by weight of sodium oxide (Na₂O). However, to obtain a satisfactory effect, these particles must be very fine and have a median size generally less than 37 μm.

The process described in this earlier document for the manufacture of these glass particles is relatively expensive to implement on an industrial scale, since it requires prolonged grinding and the use of a confined space and specific means of personal protection to obtain and use the particles in question.

Furthermore, it has been observed that soda-lime-silica glass particles in accordance with the teaching of this earlier document release practically no silicon in the presence of the acids usually released by plants and that the quantities of phytoliths formed in plants treated with these soda-lime glass particles remain relatively low, reflecting limited silicon uptake.

In document FR 3051463, it was shown that silicon stimulates the uptake of nitrogen, in particular in the form of urea, in plants. Many sources of silicon are mentioned in this document, such as solid or liquid mineral forms, vitreous products or organic silicas. In the examples highlighting the stimulation of nitrogen absorption, sodium silicate is used with a nickel contribution.

However, it has been observed that, despite nearly immediate dissolution in the presence of acids that can be generated by the soil, sodium silicate leads to limited phytolith formation in plants, again reflecting limited silicon uptake.

### DISCLOSURE OF THE INVENTION

In this context, the purpose of the present invention is to solve the technical problem of providing a source of silicon assimilable by plants and leading to the formation of a large amount of phytoliths, which can be obtained and used in a simple and inexpensive manner on an industrial scale.

It has been discovered, and this constitutes the basis of the present invention, that specific aluminosilicate glasses, used in particular in the form of particles, are particularly effective in providing a plant with silicon in an assimilable form. It has been shown, in particular, that these glasses lead to the formation of high quantities of phytoliths, unlike the silicon sources described in the related art. In addition, it has been observed that this silicon input can be obtained with particles of larger sizes than those described in document WO 2010/040176 and is therefore cheaper to obtain on an industrial scale. Finally, these aluminosilicate particles can be formulated without difficulty in fertilizer compositions, in particular in the form of granules, making them particularly easy to use in agriculture.

Without being bound by a theoretical interpretation, the inventors believe that the improved absorption of silicon in assimilable form, demonstrated by the presence of a significant amount of phytoliths in the plant, is the consequence of the ability of aluminosilicate glass to dissolve congruently under the action of organic acids released by plants.

Thus, it has been observed that silica, although a structural constituent of glass, dissolves along with the other constituents in acidic media identical to the organic acids released by plants. Therefore, the silicon supply to plants is done in a progressive and controlled way.

Moreover, because of its particular composition, and in particular its high alumina content, this aluminosilicate glass dissolves little if at all in an aqueous medium close to a neutral pH, which makes it possible to formulate it in fertilizer compositions, in particular in the form of granules.

Thus, according to a first aspect, the subject matter of the present invention is the use of an aluminosilicate glass comprising the following constituents, in a weight content varying within the limits defined below:
SiO₂ 30-60%
Al₂O₃ 10-26%
CaO+MgO+Na₂O+K₂O 15-45%
   as source of silicon, to provide a plant with silicon in assimilable form.

According to a second aspect, the subject-matter of the present invention is a method for treating a plant, characterized in that, with a view to providing this plant with silicon in assimilable form, an aluminosilicate glass as defined in the following description is applied to said plant, or to the growth medium of said plant.

According to a third aspect, the subject-matter of the present invention is an aluminosilicate glass powder as defined above, said powder having a particle size distribution such that the volume median diameter of these particles “D50” is comprised between 60 and 250 microns, preferably between 75 and 180 microns.

### Definitions

For the purposes of the present description:
“plant” means the plant considered as a whole, including its root system, its vegetative apparatus, grains, seeds and fruits;
particle “diameter” means the diameter of the equivalent sphere in volume of said particle; “DX” is the value expressed in microns of the diameter of particles such that, in a given sample of particles, and taking into account a particle size distribution in volume, X % of the distribution has a diameter smaller than this diameter DX; for example, in the case of a powder having a D90 equal to 300 microns, the particles having a diameter smaller than 300 microns occupy 90% of the total volume of the sample. In other words, in a cumulative volume distribution, the value DX corresponds to the diameter for which the cumulative function is X %; the particle size distribution in volume can be obtained in particular by laser diffraction;
“fertilizing substance” means any product or composition whose use is intended to ensure or improve the physical, chemical or biological properties of soils and plant nutrition;
“fertilizer” means any fertilizer whose main function is to provide plants with nutrients which may be major, secondary or trace elements;
“silicon-accumulating plant” means any plant likely to contain more than 1% (weight/weight) of silicon in relation to the dry mass of the plant and a Si/Ca molar ratio greater than 1.

General definition of an aluminosilicate glass within the meaning of the invention.

In general, the aluminosilicate glass used according to the invention comprises the following constituents, in a weight content varying within the limits defined hereafter:
SiO₂ 30-60%
Al₂O₃ 10-26%
CaO+MgO+Na₂O+K₂O 15-45%
K₂O 0-10%
Fe₂O₃ (total iron) 0-15%
P₂O₅ 0-4%

Preferred contents according to the invention.

The SiO₂ content is preferably comprised in a range from 35 to 49%, in particular from 36 to 45% or even from 38 to 44%.

The Al₂O₃ content is preferably comprised in a range from 12 to 25%, in particular from 14 to 24% or even from 15 to 23%.

It has been found that an aluminosilicate glass with SiO₂ and Al₂O₃ contents falling within the general and preferred ranges defined above has the advantageous property of being able to dissolve congruently under the action of organic acids released by the plants and thus release silicon that can be directly assimilated by the plants. It has also been found that such a glass dissolves little if at all in aqueous media close to neutral pH, which is particularly advantageous from an industrial point of view since this glass can be used without any particular constraints in the preparation of fertilizers, particularly in the form of granules.

The sum of the contents of CaO, MgO, Na₂O and K₂O (denoted CaO+MgO+Na₂O+K₂O) is preferably comprised in a range from 20 to 40%, in particular from 25 to 35%. The presence of these alkaline earth and alkali oxides facilitates the melting of the glass and also contributes favorably to the dissolution of the glass in contact with organic acids.

The CaO content is preferably comprised in a range from 8 to 30%, preferably from 10 to 30%, in particular from 12 to 28%. The MgO content is preferably comprised in a range from 1 to 15%, in particular from 1 to 12% or even from 1 to 11%.

The Na₂O content is preferably comprised in a range from 0 to 12%, in particular from 1 to 10%. The K₂O content is preferably comprised in a range from 0 to 8%, preferably from 1 to 8%, in particular from 1 to 7%, or even from 1 to less than 5%.

According to an embodiment, the sum of the CaO and MgO contents is comprised in a range from 25 to 40%, in particular from 27 to 35%, and the sum of the Na₂O and K₂O contents is comprised in a range from 0 to 6%, in particular from 0 to 5%, or even from 1 to 5%.

According to another embodiment, the sum of the CaO and MgO contents is comprised in a range from 10 to 25%, in particular from 12 to 20%, and the sum of the Na₂O and K₂O contents is comprised in a range from 8 to 15%, in particular from 9 to 13%.

The total iron oxide content, expressed as Fe₂O₃, is preferably comprised in a range from 0 to 13%, in particular from 2 to 12%, or even from 4 to 12%. Iron oxide may be present in the form of ferrous oxide FeO and/or ferric oxide Fe₂O₃. Redox, defined as the ratio of the ferrous oxide content, expressed as FeO, to the total molar iron oxide content, expressed as Fe₂O₃, is preferably comprised in a range from 0.1 to 0.9, in particular from 0.2 to 0.9.

Preferably the total content of SiO₂, Al₂O₃, CaO, MgO, Na₂O, K₂O, and Fe₂O₃ is at least 94%, in particular at least 95% and even at least 96% or at least 97%.

The P₂O₅ content is preferably less than or equal to 4%, in particular to 3%, or even to 2% and even to 1%. It is advantageously at most 0.5% and even zero, except for unavoidable impurities.

The BaO content is preferably less than or equal to 5%, in particular to 4%, or even to 3% and even to 2% or to 1%. It is advantageously at most 0.5% and even zero, except for unavoidable impurities.

The SrO content is preferably less than or equal to 5%, in particular to 4%, or even to 3% and even to 2% or to 1%. It is advantageously at most 0.5% and even zero, except for unavoidable impurities.

The ZnO content is preferably less than or equal to 5%, in particular to 4%, or even to 3% and even to 2% or to 1%. It is advantageously at most 0.5% and even zero, except for unavoidable impurities.

The B₂O₃ content is preferably less than or equal to 5%, in particular to 4%, or even to 3% and even to 2% or to 1%. It is advantageously at most 0.5% and even zero, except for unavoidable impurities.

The TiO₂ content is preferably less than or equal to 5%, in particular to 4%, or even to 3% and even to 2% or to 1%.

The ZrO₂ content is preferably less than or equal to 5%, in particular to 4%, or even to 3% and even to 2% or to 1%. It is advantageously at most 0.5% and even zero, except for unavoidable impurities.

Other components may be present in the chemical composition of the aluminosilicate glass used according to the invention, either voluntarily or as impurities present in the raw materials or coming from the refractories of the furnace. These may be, in particular, SO₃, resulting from the addition of sodium or calcium sulfate as a glass refiner.

It goes without saying that the various preferred ranges described above can be freely combined with each other, as not all combinations can be listed for reasons of brevity.

Several preferred combinations are described below.

According to a preferred embodiment, the aluminosilicate glass used according to the invention has a chemical composition comprising the following constituents in a weight content varying within the limits defined below:
SiO₂ 35-49%
Al₂O₃ 12-24%
CaO+MgO+Na₂O+K₂O 20-40%
Fe₂O₃ 0-12%.

According to a particularly preferred embodiment, this glass has a chemical composition comprising the following constituents in a weight content varying within the limits defined below:
SiO₂ 36-45%
Al₂O₃ 14-23%
CaO+MgO+Na₂O+K₂O 25-35%
Fe₂O₃ 0-10%.

The different preferred ranges listed above for the other oxides are of course applicable to these preferred embodiments. In particular, the P₂O₅ content is preferably less than or equal to 4%, in particular to 3%, the BaO content is preferably less than or equal to 5%, in particular to 4%, the SrO content is preferably less than or equal to 5%, in particular to 4%, the ZnO content is preferably less than or equal to 5%, in particular to 4%, the B₂O₃ content is preferably less than or equal to 5%, in particular to 4%, the TiO₂ content is preferably less than or equal to 5%, in particular to 4%, the ZrO₂ content is preferably less than or equal to 5%, in particular to 4%.

The aluminosilicate glass used according to the invention can be manufactured by all known melting methods. A vitrifiable mixture containing natural and/or artificial raw materials is heated to a temperature of at least 1300° C., in particular between 1400 and 1600° C., in order to obtain a molten glass mass. The raw materials are selected from, among others, silica sand, feldspar, basalt, bauxite, blast furnace slag, nepheline, nepheline syenite, limestone, dolomite, phonolite, sodium carbonate, potassium carbonate, iron oxide, gypsum, sodium sulfate, calcium phosphate. The vitrifiable mixture is heated in particular in a glass furnace, by means of flames from aerial or immersed burners and/or electrodes, or in a cupola, by the combustion of coke.

Aluminosilicate glass is obtained after cooling the vitrified mixture thus prepared.

In the context of the present invention, the aluminosilicate glass defined above is preferably used in the form of particles, in particular particles having a size distribution such that the volume median diameter of these particles “D50” is comprised between 60 and 250 microns, preferably between 75 and 180 microns.

Advantageously, these particles will also have a D90 value comprised between 150 and 600 microns, preferably between 150 and 350 microns, and even more preferably between 150 and 300 microns.

Advantageously, these particles will also have a D10 value comprised between 10 and 40 microns, preferably between 15 and 30 microns.

These particles can be obtained by grinding the glass prepared as indicated above, for example by means of a pendulum mill associated with an aerodynamic selector, or a ball mill. These particles can also be obtained by grinding glass fibers.

The aluminosilicate glass just described can be advantageously used in a method for treating a plant by applying an effective amount of said glass to said plant. Advantageously this method will be applied to a plant in a suboptimal nitrogen condition as will be understood below in this description.

Plants have an absolute need for nitrogen. Indeed, nitrogen is the pivot of their growth and a determining nutrient of the yield because it is the main factor limiting the development of the plant. For this reason, crop growth, yield and quality depend on substantial nitrogen inputs.

Today, nitrogen use in agriculture accounts for more than 80 million tons per year worldwide, and crop production must continue to grow with the growing demand of the world's population. However, the increasing use of nitrogen in agriculture poses ecological problems. As a result, improving yields, while preserving the environment through sustainable agricultural production, is a major challenge for today's agriculture.

The use of fertilizers specifically developed to better meet plant nitrogen requirements has led to a considerable improvement in agricultural production. However, these fertilizers are expensive to produce and their use can be environmentally problematic because of the loss to the environment of excess nitrogen that is not properly assimilated by the plant. It is therefore absolutely necessary to maximize the efficiency of nitrogen fertilizer use. This efficiency corresponds to the ratio between production (yield) and the units of fertilizer applied. It depends on several complex processes linked to the development of the plant, the variety (genetic factor) and the environmental conditions (climate, type of soil, etc.).

Although applying more nitrogen results in higher yields, it is not a linear relationship. There is an “optimal” rate of application that will achieve the optimum yield, i.e., beyond which the yield will not increase, so excess nitrogen will be lost to the environment. This results in poor nitrogen efficiency.

As shown in FIG. 1, as an example in the case of wheat (Triticum aestivum), a low nitrogen supply of 48, 96 or 144 Kg N·ha⁻¹ yr⁻¹ leads to stunted growth and therefore low yields. On the other hand, nitrogen losses are low. An optimal nitrogen supply of 192 Kg N·ha⁻¹ yr⁻¹ or excess nitrogen (amounts greater than 192 Kg N·ha⁻¹ yr⁻¹) leads to high yields, but is accompanied by high nitrogen losses and low nitrogen efficiency.

Thus, in order to limit nitrogen losses to the environment, and to reduce the impact of fertilization on the environment, while generating financial gain, it is essential to achieve optimum yield with less than the optimum amount of nitrogen (nitrogen inputs).

In this context, the method conforming to the invention is particularly advantageous since it has been shown that the use of the above-mentioned aluminosilicate glass makes it possible to increase the yield under suboptimal nitrogen supply conditions to a level close to or even identical to the level obtained under optimal nitrogen supply conditions, thus perfectly meeting the growth requirements of the crop.

For the purposes of the present description, “suboptimal nitrogen dose” means a dose corresponding to a reduction of at least 20%, preferably at least 30%, of the optimum dose calculated to achieve optimum yield.

The optimal nitrogen dose needed to maximize production is calculated according to the plant's needs. As shown in Table 1, these requirements may vary depending on the variety and soil-climatic conditions, among other things.

TABLE 1

| | Optimal nitrogen dose to | Sub-optimal dose of nitrogen |
|---|---|---|
| | achieve optimal yield | not achieving optimal yield |
| Cultures | (Kg N/ha) | (Kg N/ha) |
| Rapeseed | 230 to 260 | 160 to 180 |
| Sugar cane | 120 to 150 | 84 to 105 |
| Wheat | 240 to 280 | 168 to 195 |
| Barley | 160 to 180 | 112 to 126 |
| Corn | 230 to 250 | 160 to 175 |
| Sunflower | 115 to 160 | 80 to 110 |
| Grassland | 140 to 200 | 100 to 140 |
| Soya | 80 to 150 | 55 to 105 |
| Rice | 160 to 180 | 110 to 125 |
| Oats | 160 to 180 | 110 to 125 |

Thus, by making it possible to reduce the doses of nitrogen applied while maintaining yields at their optimal level, the treatment method according to the invention provides a response to the undesirable effects on the environment of fertilization by nitrates (leaching problem) or by urea (volatilization problem).

In a particular embodiment, the treated plant is chosen from rice, grassland, rapeseed, sunflower, wheat, oats, sugar cane, barley, soya, maize, preferably grassland.

The aluminosilicate glass used according to the invention therefore acts as a stimulant of growth and yield mechanisms, particularly under suboptimal nitrogen supply conditions, in a plant. The present invention thus covers the use of an aluminosilicate glass as previously defined to increase the yield under suboptimal nitrogen supply conditions in a plant.

For the purposes of the invention, “yield stimulant under suboptimal nitrogen input conditions” means the activity that results in an increased yield increase of at least 10% under low nitrogen input conditions.

The aluminosilicate glass used according to the invention also acts as a stimulant of nitrogen efficiency, particularly under suboptimal nitrogen supply conditions, in a plant. The present invention thus also covers the use of an aluminosilicate glass as previously defined to increase the nitrogen efficiency under suboptimal nitrogen supply conditions in a plant.

For the purposes of the invention, “nitrogen efficiency stimulant under suboptimal nitrogen input conditions” means the activity that results in an increased increase of at least 10% in nitrogen efficiency under low nitrogen input conditions.

In the method of the invention, an effective amount of an aluminosilicate glass is provided to the plant to stimulate nitrogen yield and efficiency under suboptimal nitrogen conditions.

The expression “effective amount” means an amount to increase the yield and nitrogen efficiency of a plant under suboptimal nitrogen supply conditions by at least 10%, at least 15%, at least 20%, at least 25%, at least 30%, advantageously by at least 30%, at least 35%, at least 40%, at least 45%, advantageously by at least 50%, at least 55%.

The increase in yield is measured by determining the biomass produced by the plant. The term “increase” refers to the plant having received no input from an aluminosilicate glass.

The increase in nitrogen efficiency is measured by determining the ratio between the yield and the amount of nitrogen applied to the plant. The term “increase” refers to a plant that has not received any input from a glass of aluminosilicate.

In the method of treating a plant according to the invention, the aluminosilicate glass is advantageously provided to the plant by the roots.

This treatment can be applied in particular in the field but also in greenhouses, possibly in off-ground substrates (hydroponics).

In a particular embodiment, the aluminosilicate glass is provided to the plant in an amount ranging from 2 Kg/ha (kilograms/hectare) to 1000 Kg/ha. In this embodiment, the aluminosilicate glass is advantageously spread evenly over a field or a crop of plants.

In another particular embodiment, the aluminosilicate glass is provided to the plant in solid form in powder/pulverulent or granular fertilizers, preferably in an amount ranging from 5 to 800 Kg/Ton of fertilizer (T) and preferably in the order of 50 to 300 Kg/Ton of fertilizer (T).

Aluminosilicate glass can thus be used as a supplement in fertilizer compositions, such as fertilizers, as a yield and nitrogen efficiency booster under suboptimal nitrogen supply conditions in a plant. In particular, this glass can be combined with other fertilizing substances conventionally used in fertilizer compositions.

In a particular embodiment of the invention, an effective amount of an aluminosilicate glass is used in a fertilizer composition in association with one or more fertilizing substances. The fertilizing substances which may be used in association with the aluminosilicate glass may be of various kinds and selected for example from urea, a nitrogen solution, ammonium sulfate, ammonium nitrate, rock phosphate, potassium chloride, ammonium sulfate, magnesium nitrate, manganese nitrate, zinc nitrate, copper nitrate, phosphoric acid, boric acid. Advantageously, this additional fertilizer substance is selected from urea, ammonium sulfate, ammonium nitrate, nitrogen solution and/or potassium nitrate.

The invention also relates to a method for stimulating the yield and nitrogen efficiency under suboptimal nitrogen supply conditions in a plant, characterized in that it comprises supplying to said plant or to the soil, an effective amount of the aluminosilicate glass as previously defined.

The aluminosilicate glass according to the invention may be incorporated in formulations intended for the preparation of fertilizers in granular form.

These granules can be prepared in the usual way, either dry, for example by compacting the powder mixture between two cylindrical rollers, or wet, for example by wetting the powder mixture with a liquid binder, followed by drying and grading and/or sieving.

These granules may in particular have the following weight compositions:
Nitrogen: from 20 to 28%
SO₃: from 18 to 23%
CaO: from 4 to 8%
SiO₂: from 6 to 10%

These granules will preferably be obtained by the wet process by mixing urea, ammonium sulfate, potassium chloride, calcium carbonate and a granulation binder.

The present invention will now be illustrated by the following non-limiting examples, with reference to the appended FIGS. 1 to 5.

In these examples, unless otherwise stated, percentages are by weight and the temperature is room temperature.

The following abbreviations were used:
L: liter
V/V: volume/volume
Kg N·ha⁻¹yr⁻¹: kilograms of nitrogen per hectare per year.

### BRIEF DESCRIPTION OF THE DRAWINGS

FIG. 1 is a graph showing the impact of nitrogen fertilizer application on (i) grain yield (solid and diamond lines), (ii) nitrogen leaching losses (bar graph) and (iii) nitrogen efficiency (dashed and square lines).

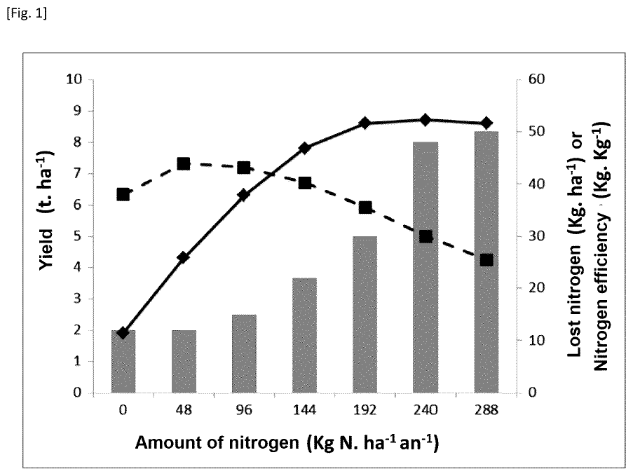

FIG. 2 is a graph representing the percentage of silicon (of an aluminosilicate glass according to the invention) dissolved in various acids.

FIG. 3 is a graph representing the percentage of silicon (from an aluminosilicate glass according to the invention, calcium silicate, diatomaceous earth and soda-lime-silica glass) dissolved in various acids (malic acid A, oxalic acid B, citric acid C and succinic acid D).

FIG. 4 reproduces the photographs showing the formation of phytoliths in a leaf of rice (Oryza sativa) treated with an aluminosilicate glass according to the invention (V1) and with sodium silicate.

FIG. 5 is a graph that represents the yield of ryegrass plants, i.e. the dry mass of ryegrass plants, (i) with a nitrogen-free feed, (bar “0”); (ii) with a feed containing 60 Kg·ha¹ of nitrogen, (bar “60”); (iii) with a feed containing 100 Kg·ha⁻¹ of nitrogen, (bar “100”); this dose being considered the suboptimal nitrogen dose that does not achieve optimal yield, (iv) with a feed that includes 140 Kg·ha⁻¹ of nitrogen, (bar “140”), this dose being considered as the optimal nitrogen dose which allows the optimal yield to be achieved, and (v) with a feed which comprises 100 Kg·ha⁻¹ of nitrogen and 50 Kg·ha⁻¹ of an aluminosilicate glass according to the invention, (bar “100+aluminosilicate glass”).

FIG. 6 is a graph representing the nitrogen efficiency of ryegrass plants, i.e., the dry mass of ryegrass plants divided by the amount of nitrogen supplied, (i) with a feed which comprises 60 Kg·ha⁻¹ of nitrogen, (bar “60”); (ii) with a feed which comprises 100 Kg·ha⁻¹ of nitrogen, (bar “100”); (iii) with a feed which comprises 140 Kg·ha⁻¹ of nitrogen, (bar “140”); (optimum nitrogen dose which allows optimum yield to be achieved) and (iv) with a feed which comprises 100 Kg·ha⁻¹ of nitrogen and 50 Kg·ha⁻¹ of an aluminosilicate glass according to the invention, (bar “100+aluminosilicate glass”).

FIG. 7 is a histogram showing the particle size distribution of a glass powder used according to the invention.

### DESCRIPTION OF THE EMBODIMENTS

### Example 1: Preparation of Aluminosilicate Glass Particles According to the Invention

Two aluminosilicate glass compositions illustrative of the invention were prepared by melting a suitable vitrifiable mixture in accordance with a usual method of obtaining a molten glass mass.

The compositions of these two aluminosilicate glasses are given in Table 2 below.

TABLE 2

| | «Glass 1» | «Glass 2» |
|---|---|---|
| SiO₂ | 40.8 | 43.1 |
| Al₂O₃ | 16.8 | 22.8 |
| Na₂O | 1.7 | 6.2 |
| K₂O | 1.4 | 4.0 |
| MgO | 6.0 | 1.8 |
| CaO | 25.0 | 14.6 |
| Fe₂O₃ | 5.8 | 5.8 |
| Impurities | 2.5 | 1.7 |

After cooling, the mass of glass obtained was crushed by means of a pendulum mill associated with an aerodynamic selector (mill in which the crushing is obtained by crushing the glass between a fixed cylindrical ring with a vertical axis and centrifugal rollers by the rotation of their support).

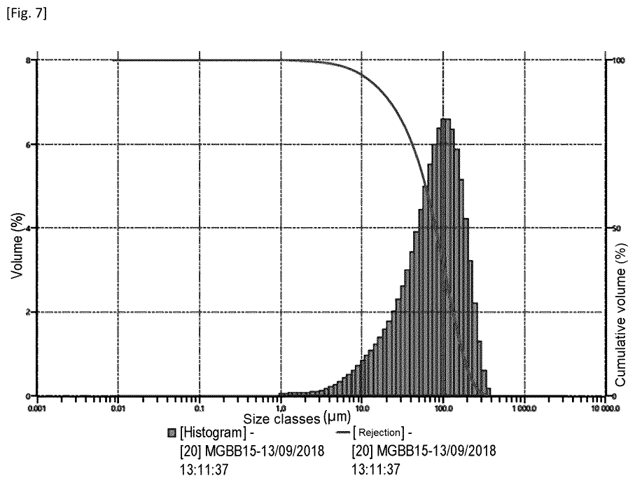

The particle size of the glass particles thus obtained was measured by laser diffraction sizing and FIG. 7 shows the particle size distribution of these particles.

In this example, the following operating conditions were used:

Device Used:
Mastersizer 2000, Malvern
Accessory Hydro Cell 2000

Operating Parameters:
Liquid process
Dispersant: alcohol
Refractive index (particle):1.52
Absorption index (particle):0.01
Stirring speed: 2000 rpm
Ultrasonic use: no
Measurement time: 6 seconds
Blank measurement time: 6 seconds
Obscuration range: 6.21%.

The powder obtained had the following characteristic values:
D90: 189 microns
D50: 81 microns
D10: 18.4 microns

### Example 2: Demonstration of the Dissolution Properties of an Aluminosilicate Glass According to the Invention in the Presence of Organic Acids

Plants have the particularity of releasing various organic acids through their roots, such as in particular citric acid, lactic acid, malic acid, oxalic acid, succinic acid, formic acid, acetic acid, pyruvic acid, maleic acid, oxaloacetic acid, ascorbic acid, isocitric acid.

In order to demonstrate the special dissolution properties of an aluminosilicate glass according to the invention in these organic acids, particles of glass 1 prepared according to example 1 were treated with the following protocol.

Preparation of Media with Different Organic Acids

Several media were prepared, and their composition is presented in the following table 3:

TABLE 3

| | | pH of the |
|---|---|---|
| Medium | Composition of the medium | medium |
| Ultrapure water | Ultrapure water | 7.0 |
| Sulfuric acid | Ultrapure water adjusted to pH 2 with concentrated sulfuric acid | 2.0 |
| Nitric acid | Ultrapure water adjusted to pH 2 with concentrated nitric acid | 2.0 |
| Hydrochloric acid | Ultrapure water adjusted to pH 2 with concentrated hydrochloric acid | 2.0 |
| Phosphate citrate buffer | 360 mL 0.5M Na2HPO4 + 220 mL 0.5M citric acid + 1420 mL | 4.5 |
| | ultrapure water | |
| Phosphate oxalate buffer | 360 mL 0.5M Na2HPO4 + 220 mL 0.5M oxalic acid + 1420 mL | 4.2 |
| | ultrapure water | |
| Phosphate tartrate | 360 mL of 0.5M Na2HPO4 + 220 mL of 0.5M tartaric acid + 1420 mL | 4.4 |
| buffer | of ultrapure water | |
| Citric acid 2%. | 40 g citric acid in 2 L ultrapure water | 2.0 |
| Succinic acid 2%. | 40 g succinic acid in 2 L ultrapure water | 2.5 |
| Oxalic acid 2%. | 40 g oxalic acid in 2 L ultrapure water | 1.2 |
| Tartaric acid 2%. | 40 g tartaric acid in 2 L ultrapure water | 2.0 |
| Malic acid 2% | 40 g malic acid in 2 L ultrapure water | 2.1 |
| Glucuronic acid 2% | 40 g glucuronic acid in 2 L ultrapure water | 2.1 |
| Pyruvic acid 2%. | 40 g pyruvic acid in 2 L ultrapure water | 1.6 |
| Malonic acid 2% | 40 g malonic acid in 2 L ultrapure water | 1.8 |
| Gluconic acid 2% | 40 g gluconic acid in 2 L ultrapure water | 2.3 |
| Phosphate buffer | 2.75 g KH2PO4 in 2 L ultrapure water adjusted to pH 8.5 | 8.5 |
| Phosphate buffer | 2.75 g KH2PO4 in 2 L ultrapure water adjusted to pH 11 | 11 |

Dissolution Test

100 mg of each product was placed in a 60 ml pill box. 50 ml of each dissolution medium was added and then put under continuous stirring with a rotary shaker (Heidolph reax 2). After 48 h of stirring, the samples were filtered with filter paper with a pore diameter of 15 μm. The silicon was measured to determine the percentage of dissolution in each medium.

Silicon Measurement

The determination of the silicon (Si) content of the samples was carried out for each sample and for each sampling time by inductively coupled plasma-optical emission spectroscopy using ICP-OES (Inductively Coupled Plasma-Optical Emission Spectroscopy, Thermo Elemental Co. Iris Intrepid II XDL).

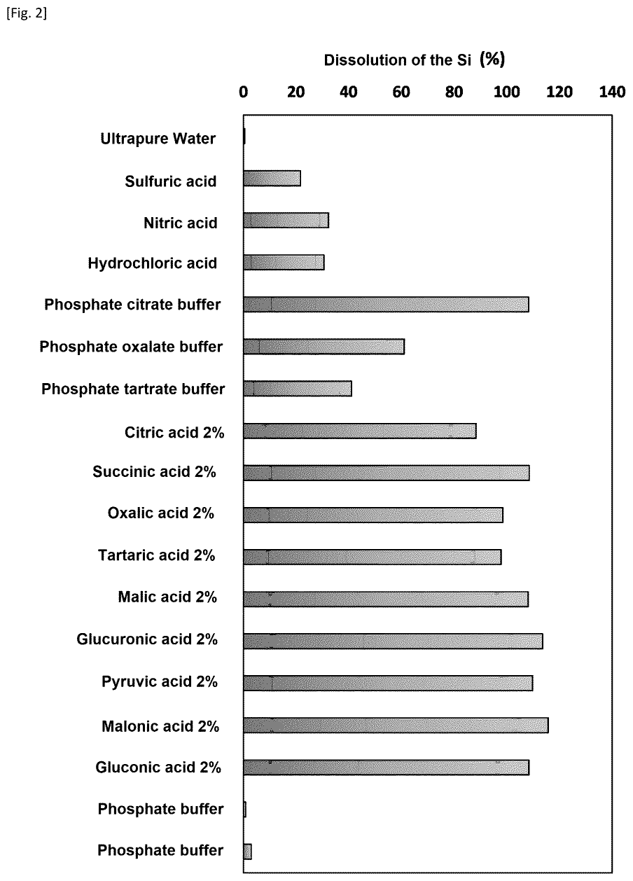

The results are shown in FIG. 2.

As can be seen, the aluminosilicate glass according to the invention is solubilized in the presence of the organic acids usually released by plants.

On the other hand, it is noted that no silicon release occurs in aqueous media close to neutral pH.

This figure also shows that the solubility effect of aluminosilicate glass is not related to pH alone, since the dissolution of silicon is relatively weak in strong acids such as sulfuric, nitric or hydrochloric acid.

Other tests showed that the release of silicon is congruent with the release of the other constituents of the glass.

### Example 3: Demonstration of the Dissolution Properties of an Aluminosilicate Glass According to the Invention in the Presence of Organic Acids in Comparison with Other Forms of Silicon

In order to demonstrate the particular dissolution properties of an aluminosilicate glass according to the invention in certain organic acids, and to be able to compare this dissolution with that of other forms of silicon, particles of glass 1 prepared according to example 1, calcium silicate, diatomaceous earth and a soda-lime-silica glass illustrating the teaching of document WO 2010/040176 were treated according to the following protocol:

Preparation of Media with Different Organic Acids

4 media each containing a phosphate buffer and an organic acid were prepared:
Medium 1, based on malic acid, is composed of: 360 mL of 0.5M Na₂HPO₄, 220 mL of 0.5M malic acid made up to 2 L with ultrapure water. The measured pH is 4.9
Medium 2, based on citric acid, is composed of: 360 mL of 0.5M Na₂HPO₄, 220 mL of 0.5M citric acid made up to 2 L with ultrapure water. The measured pH is 4.5
Medium 3, based on oxalic acid, is composed of: 360 mL of 0.5M Na₂HPO₄, 220 mL of 0.5M oxalic acid made up to 2 L with ultrapure water. The measured pH is 4.2
Medium 4, based on succinic acid, consists of 2% succinic acid prepared with 40 g of succinic acid supplemented to 2 L with ultrapure water. The measured pH is 2.4

Dissolution Test

100 mg of each product was placed in a 60 ml pill box. 50 ml of dissolution medium was added and then put under continuous stirring with a rotary shaker (Heidolph reax 2). Successive samples of solution are then taken after 1, 2, 5, 8, 24 and 48 h of stirring. The samples taken are filtered with a filter paper with a pore diameter of 15 μm. The silicon assay was carried out for each sample to determine its dissolution kinetics in the medium.

Silicon Measurement

The determination of the silicon (Si) content of the samples was carried out for each sample and for each sampling time by inductively coupled plasma-optical emission spectroscopy using ICP-OES (Inductively Coupled Plasma-Optical Emission Spectroscopy, Thermo Elemental Co. Iris Intrepid II XDL).

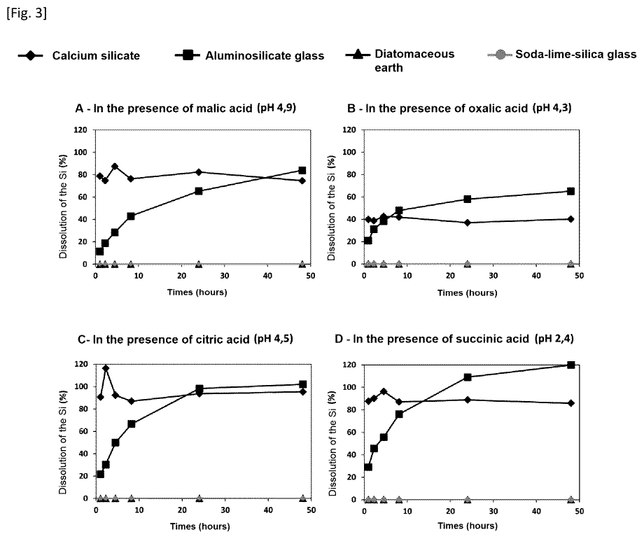

The results are shown in FIG. 3.

As can be seen, the aluminosilicate glass according to the invention is gradually solubilized in the presence of the organic acids usually released by plants, such as malic acid A, oxalic acid B, citric acid C or succinic acid D). On the other hand, no release of silicon occurs in these media for diatomaceous earth or soda-lime-silica glass products.

### Example 4: Demonstration of the Formation of Phytoliths in a Plant Treated with an Aluminosilicate Glass According to the Invention

Preparation of Plant Material

Oryza sativa L. Var ARELATE rice seeds were placed at +4° C. the day before germination to ensure a homogeneous emergence. They were then sown on a perlite layer in tanks containing demineralized water and left in the dark for 10 days before being provided to light. After 7 days, the seedlings were transplanted into 2 L pots containing a mixture of clay beads and vermiculite (50%/50%; V/V) and then received the various treatments at the time of transplanting. The plants were watered three times a week with a Hoagland solution of: KNO₃ (0.2 mM); Ca(NO₃)₂, 4H₂O (0.4 mM); KH₂PO₄ (0.2 mM); MgSO₄, 7H₂O (0.6 mM), (NH₄)₂SO₄ (0.4 mM); H₃BO₃ (20 μM); MnSO₄, H₂O (5 μM); ZnSO₄, 7H₂O (3 μM); CuSO₄, 5H₂O (0.7 μM); (NH₄)₆Mo₇O₂₄, 4H₂O (0.7 μM) and Fe-EDTA (200 μM). The experiment was conducted in a growing greenhouse at 22° C. with a photoperiod of 12 h day/12 h night. The plants were harvested 48 days after application of the treatment.

Food that Did not Include Aluminosilicate Glass (Control)

These plants received only the nutrient solution described above at a frequency of three times a week. The plants were grown in a growing greenhouse at 22° C. with a photoperiod of 12 h day/12 h night.

Food that Included Aluminosilicate Glass According to Example 1

These plants received the nutrient solution described above three times a week. The aluminosilicate glass was added during transplanting at a dose of 50 Kg·ha⁻¹ (corresponding to 21 Kg·ha⁻¹ of SiO₂). The plants were grown in a culture greenhouse at 22° C. with a photoperiod of 12 h day/12 h night.

Food that Included Sodium Silicate

These plants received the nutrient solution described above three times a week. Sodium silicate was added during transplanting at a dose of 42.6 Kg·ha⁻¹, in order to have the same SiO₂ equivalent (21 Kg·ha⁻¹). The plants were grown in a culture greenhouse at 22° C. with a photoperiod of 12 h day/12 h night.

Observation and Quantification of Phytoliths in the Plant

For each of the culture conditions (control, aluminosilicate glass and sodium silicate), four batches of four harvested plants were formed (1 batch=1 biological replicate). The phytolith observation method is based on the autofluorescence of phytoliths developed by Dabney III et al. Plant Methods (2016) 12:3 A novel method to characterize silica bodies in grasses.

A median section of each leaf blade was cut along the leaf of each plant, placed between two microscope slides, and then placed in a muffle furnace at 500° C. for 3 hours for complete charring of the leaf samples. After a cooling time, the slides were placed under a fluorescence microscope (Zeiss Axio Observer Z1) at ×10 magnification. The autofluorescence of the phytoliths was measured using a GFP filter, with excitation between 450-490 nm and emission between 500-550 nm. Quantification of the phytoliths was performed using “Zen 2 Pro” software. By preselecting an area of the same air on the image and for each modality, the number of phytoliths is calculated using software in “number of phytoliths. mm⁻²”.

The data obtained were presented as photos (for the observation of phytoliths) or means (for the number of phytoliths) and the variability of the results was given as a standard error of the mean for n=4. A statistical analysis of the results was performed using Student's test.

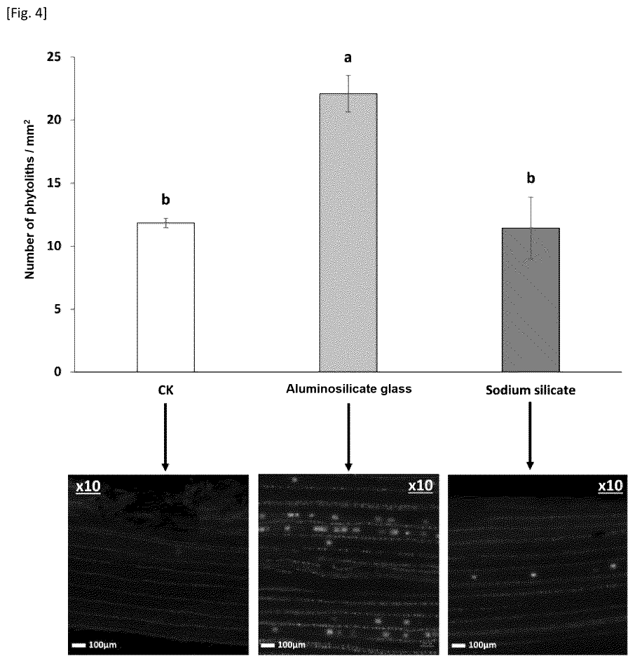

The accumulation of phytoliths in the plant is shown in FIG. 4.

Conclusion: plants treated with aluminosilicate glass show a greater accumulation of phytoliths in the leaves. The number of phytoliths in the presence of aluminosilicate glass increases by +86%, compared to the control, and by +93%, compared to sodium silicate. This reflects a better absorption of silicon by the plant in the presence of the aluminosilicate glass according to the invention.

Additional tests, the results of which are not reported here, have shown that a soda-lime glass illustrating the teaching of WO 2010/040176 also leads to limited phytolith formation.

### Example 5: Demonstration of Improved Yield and Nitrogen Efficiency Under Suboptimal Nitrogen Conditions in a Plant Treated with an Aluminosilicate Glass According to the Invention

Preparation of Plant Material

Lolium perenne L. Var Abys ryegrass seeds were sown at a density of 240 Kg·ha⁻¹ (corresponding to 2 g of seeds per pot) in 2 L pots containing a mixture of soil and sand (50/50—V/V) and then placed in a glasshouse under the following conditions: daytime temperature of 25° C. and a photoperiod of 12 h/nighttime temperature of 20° C. and a photoperiod of 12 h. The soil used had the following characteristics: sandy loamy soil, pH 7.1 and contained 1.6% organic matter. Throughout the trial period, the plants were watered by weight to maintain the soil at 70% of its capacity in the field.

The term “watered by weight”, as used in this description, means that the watering is done in an amount to compensate for water losses that may occur through evapotranspiration. In this case, water is added in an amount that will bring the weight of the pot back to its original weight.

In order to draw residual nitrogen from the soil to obtain a nitrogen response curve, the plants were cultivated for 24 days before making the first cut. This first cut was not analyzed because no treatment was applied at this stage, the objective being to take up the residual nitrogen initially present in the soil. Subsequent treatments were applied 28 days after sowing (4 days after the first cut), varying the amount of nitrogen applied (0, 60, 100, 140 Kg·ha⁻¹):
the first nitrogen fertilization was carried out 28 days after sowing
the second cut/harvest was carried out 68 days after sowing
the second nitrogen fertilization was carried out 69 days after sowing
the third cut/harvest was carried out 103 days after sowing

The biomass of the plants harvested in the second and third cut were then added together to give the total biomass.

The following observations were made.

Food that Did not Include Nitrogen—(0 Kg·Ha⁻¹)

No nitrogen fertilization was applied to the seedlings. This condition is considered a nitrogen deficiency condition as it does not allow optimal yield to be achieved. The plants were watered by weight throughout the trial period to maintain the soil at 70% of its field capacity.

Food that Included 60 Kg of Nitrogen Per Hectare—(60 Kg·Ha⁻¹)

These plants received 60 Kg of N·ha⁻¹ at the first fertilization in the form of urea, and no nitrogen was applied at the second nitrogen fertilization. This condition is considered as a nitrogen deficiency condition as it does not allow to reach an optimal yield. Plants were watered by weight throughout the trial period in order to maintain the soil at 70% of its field capacity.

Food that Included 100 Kg of Nitrogen Per Hectare—(100 Kg·Ha⁻¹)

These plants received 60 Kg of N·ha⁻¹ as urea at the first fertilization, and 40 Kg of N·ha⁻¹ as urea at the second nitrogen fertilization. This condition is considered as a suboptimal nitrogen condition as it does not allow to reach an optimal yield. The plants were watered by weight throughout the trial period in order to maintain the soil at 70% of its capacity in the field.

Food that Included 140 Kg of Nitrogen Per Hectare—(140 Kg·Ha⁻¹)

These plants received 60 Kg of N·ha⁻¹ as urea at the first fertilization, and 80 Kg of N·ha⁻¹ as urea at the second nitrogen fertilization. This condition is considered an optimal nitrogen condition because it allows to reach an optimal yield. The plants were watered by weight throughout the trial period in order to maintain the soil at 70% of its capacity in the field.

Food that Included 100 Kg of Nitrogen Per Hectare and 50 Kg·Ha⁻¹ of an Aluminosilicate Glass According to Example 1 (Glass 1)

These plants received 60 Kg of N·ha⁻¹ as urea at the first fertilization, and 40 Kg of N·ha⁻¹ as urea at the second nitrogen fertilization. The aluminosilicate glass was provided during the first fertilization at the dose of 50 Kg·ha⁻¹ and in association with the urea. This condition is considered to be a suboptimal nitrogen condition as it does not allow optimum yield to be achieved. The plants were watered by weight throughout the trial period in order to maintain the soil at 70% of its capacity in the field.

Measurement of Nitrogen Yield and Efficiency

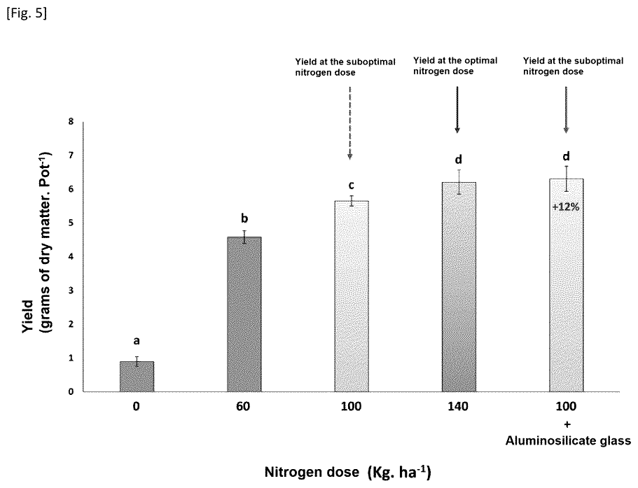

Yield was determined by evaluating leaf biomass according to the following protocol. For each of the growing conditions (0, 60, 100, 140 and 100+100 aluminosilicate glass), and for each cut/harvest (second and third cut/harvest), six batches of harvested plants were formed (1 batch=1 biological replicate). The aerial parts (leaves and stems) of the plants were weighed (fresh biomass) then dried in an oven (at 70° C. for 2 days) to obtain the total dry biomass. Biomasses from the second and third harvest were added to obtain total biomass. Measurements of the dry biomass of the plants that represents the yield are shown in FIG. 5. The data obtained were presented as a mean and the variability of the results was given as the standard error of the mean for n=6. A statistical analysis of the results was performed using Student's test.

Conclusion: Under suboptimal nitrogen conditions (i.e. 100 Kg·ha⁻¹), plants treated with the aluminosilicate glass according to the invention show a significant 12% increase in yield, which translates into better ryegrass growth under this low nitrogen condition. FIG. 5 also shows that the plants having received the suboptimal dose of nitrogen and the aluminosilicate glass have the same yield as the plants having received the optimal dose of nitrogen (140 Kg·ha⁻²). This result shows that the aluminosilicate glass according to the invention stimulates the yield under suboptimal nitrogen conditions, and makes it possible to achieve the same yield as that obtained with the plants having received the optimal dose of nitrogen.

Nitrogen efficiency was subsequently calculated using the following formula, presented by Good et al. 2004; Dawson et al. 2008:

$$Nitrogen efficiency = \frac{Total biomass produced ( cut 1 + cut 2 )}{Total amount of nitrogen provided}$$

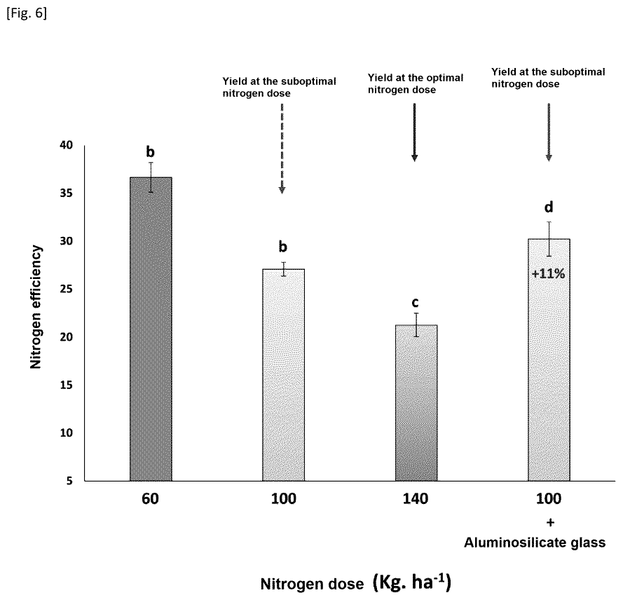

The resulting measures of nitrogen efficiency are shown in FIG. 6. The data obtained were presented as a mean and the variability of the results was given as the standard error of the mean for n=6. A statistical analysis of the results was performed using Student's test.

Conclusion: Under suboptimal nitrogen conditions (i.e. 100 Kg·ha⁻¹), plants treated with the aluminosilicate glass according to the invention show a significant 11% increase in nitrogen efficiency, which translates into a better increase in yield per unit of nitrogen supplied under this low nitrogen supply condition. This result also shows that plants having received the suboptimal dose of nitrogen and the aluminosilicate glass have a nitrogen efficiency +42% higher than that obtained with plants having received the optimal dose of nitrogen (140 Kg·ha⁻²). The aluminosilicate glass according to the invention therefore improves the nitrogen efficiency in suboptimal nitrogen conditions.

1. A method for providing a plant with silicon in assimilable form which comprises applying to said plant or to a growth medium of said plant an aluminosilicate glass comprising the following constituents in a weight content varying within the limits defined below:
SiO₂ 30-60%
Al₂O₃ 10-26%
CaO+MgO+Na₂O+K₂O 15-45%
as source of silicon.

2. The method of claim 1, wherein, in said aluminosilicate glass, the SiO₂ content by weight is between 35 and 49%.

3. The method of claim 1, wherein, in said aluminosilicate glass, the Al₂O₃ content by weight is between 12 and 25%.

4. The method of claim 1, wherein, in said aluminosilicate glass, the cumulative weight content of CaO, MgO, Na₂O and K₂O is between 20 and 40%.

5. The method of claim 4, wherein, in said aluminosilicate glass:
the weight content of CaO is between 8 and 30%; and
the weight content of MgO is between 1 and 15%.

6. The method of claim 4, wherein, in said aluminosilicate glass:
the weight content of Na₂O is between 1 and 10%;
the weight content of K₂O is between 1 and 7%.

7. The method of claim 1, wherein, in said aluminosilicate glass:
the sum of the weight contents of CaO and MgO is between 25 and 40%; and
the sum of the weight contents of Na₂O and K₂O is between 0 and 6%.

8. The method of claim 1, wherein, in said aluminosilicate glass:
the sum of the weight contents of CaO and MgO is between 10 and 25%; and
the sum of the weight contents of Na₂O and K₂O is between 8 and 15%.

9. The method of claim 1, wherein said aluminosilicate glass further comprises iron oxide and:
the total weight content of iron oxide, expressed in the form Fe₂O₃ is between 0 and 13%.

10. The method of claim 1, wherein, in said aluminosilicate glass, the total weight content of SiO₂, Al₂O₃, CaO, MgO, Na₂O, K₂O and Fe₂O₃ is at least 94%.

11. The method of claim 1, wherein said aluminosilicate glass comprises the following constituents, in a weight content varying within the limits defined below:
SiO₂ 35-49%
Al₂O₃ 12-24%
CaO+MgO+Na₂O+K₂O 20-40%
Fe₂O₃ 0-12%.

12. The method of claim 11, wherein said aluminosilicate glass comprises the following constituents in a weight content varying within the limits defined below:
SiO₂ 36-45%
Al₂O₃ 14-23%
CaO+MgO+Na₂O+K₂O 25-35%
Fe₂O₃ 0-10%.

13. The method of claim 1, wherein said aluminosilicate glass is in the form of particles having a size distribution such that the volume median diameter of the particles “D50” is between 60 and 250 microns.

14. (canceled)

15. The method f of claim 1, wherein the above plant is in a suboptimal nitrogen condition.

16. The method of claim 1, wherein the plant is selected from the group consisting of rice, grassland, rape, sunflower, wheat, oats, sugar cane, barley, soya, and maize.

17. The method of claim 1, wherein the aluminosilicate glass is provided to the plant in an amount between 20 and 500 Kg/T in a form selected from the group consisting of solid form, powder and granules.

18. The method of claim 1, wherein said aluminosilicate glass is supplied to the plant by the roots.

19. An aluminosilicate glass powder comprising:
the following constituents in a weight content varying within the limits defined below:
SiO₂ 30-60%
Al₂O₃ 10-26%
CaO+MgO+Na₂O+K₂O 15-45%; and
said glass powder having a particle size distribution such that the volume median diameter of these particles “D50” is comprised between 60 and 250 microns.

20. A fertilizer composition comprising at least one nitrogen source in admixture with at least one aluminosilicate glass as defined with comprising the following constituents in a weight content varying within the limits defined below:
SiO₂ 30-60%
Al₂O₃ 10-26%
CaO+MgO+Na₂O+K₂O 15-45%.

21. The method of claim 1, wherein, in said aluminosilicate glass, the SiO₂ content by weight is between 36 and 45%.

22. The method of claim 1, wherein, in said aluminosilicate glass, the SiO₂ content by weight is between 38 and 44%.

23. The method of claim 1, wherein, in said aluminosilicate glass, the Al₂O₃ content by weight is between 14 and 24%.

24. The method of claim 1, wherein, in said aluminosilicate glass, the cumulative weight content of CaO, MgO, Na₂O and K₂O is between 25 and 35%.

25. The method of claim 4, wherein, in said aluminosilicate glass:
the weight content of CaO is between 12 and 28%; and
the weight content of MgO is between 1 and 12%.

26. The method of claim 1, wherein, in said aluminosilicate glass:
the sum of the weight contents of CaO and MgO is between 27 and 35%; and
the sum of the weight contents of Na₂O and K₂O is between 1 and 5%.

27. The method of claim 1, wherein, in said aluminosilicate glass:
the sum of the weight contents of CaO and MgO is between 12 and 20%; and
the sum of the weight contents of Na₂O and K₂O is between 9 and 13%.

28. The method of claim 1, wherein said aluminosilicate glass further comprises iron oxide and:
the total weight content of iron oxide, expressed in the form Fe₂O₃ is between 4 and 12%.

29. The method of claim 1, wherein, in said aluminosilicate glass, the total weight content of SiO₂, Al₂O₃, CaO, MgO, Na₂O, K₂O and Fe₂O₃ is at least 97%

30. The method of claim 1, wherein said aluminosilicate glass is in the form of particles having a size distribution such that the volume median diameter of the particles “D50” is between 75 and 180 microns

31. The method of claim 1, wherein the aluminosilicate glass is provided to the plant in an amount between 50 and 300 Kg/T in a form selected from the group consisting of solid form, powder and granules.

32. The aluminosilicate glass powder of claim 19, wherein said glass powder has a particle size distribution such that the volume median diameter of these particles “D50” is comprised between 75 and 180 microns.
